(19) United States
(12) Patent Application Publication
(10) Pub. No.: US 2015/0200745 A1
(43) Pub. Date: Jul. 16, 2015

(54) WIRELESS SIGNAL INTERRUPTER FOR IN-VEHICLE MOBILE DEVICE SIGNALS

(71) Applicants: Howard S. Morris, Bryn Mawr, PA (US); David L. Grau, Wayne, PA (US)

(72) Inventors: Howard S. Morris, Bryn Mawr, PA (US); David L. Grau, Wayne, PA (US)

(21) Appl. No.: 14/597,864

(22) Filed: Jan. 15, 2015

Related U.S. Application Data
(60) Provisional application No. 61/927,765, filed on Jan. 15, 2014.
(60) Provisional application No. 61/948,246, filed on Mar. 5, 2014.

(51) Int. Cl. H04K 3/00; H04M 1/725

(52) U.S. Cl. CPC H04K 3/415; H04K 3/43; H04M 1/72577; H04M 1/72572; H04K 3/42

(57) ABSTRACT

An engine, system and method of providing wireless signal interruption for mobile device signals while in vehicle. The invention includes an electronic device of a portable size, such as the size of a hockey puck, and of a convenient shape so as to be moved about by one hand of a user, such as ovular, round, square, etc., that blocks targeted or all wireless signals while in a vehicle, or while in a portion of a said vehicle. The device may be mounted using a magnetic application somewhere inside the engine compartment area of a vehicle or on one side of the roof of the vehicle, on a door of the vehicle, or within the cab of the vehicle, such as via a Velcro, tape or like-adherent mounting, and such as to a window surface or other interior cab surface.

### CROSS-REFERENCE TO RELATED APPLICATION

This application claims the benefit of priority to U.S. Provisional Patent Application Ser. No. 61/927,765, filed Jan. 15, 2014, the entirety of which is incorporated by reference herein.

### BACKGROUND

1. Field of the Invention

The present invention relates to the three-dimensional viewing technologies, and, more particularly, to an engine, system and method for providing three dimensional content and a viewing experience for same.

2. Background of the Invention

There is a growing issue around the use of cell phones inside vehicles, and the potential impact cell phone distractions have on a driver's ability to focus. The most concerning trend within this space is texting while driving.

Below are provided several interesting statistics related to texting while driving:
23% of auto accidents in 2011 were a result of texting while driving. This translates to 1.3 million incidents;
5 seconds is the minimal amount of time attention is taken away from the road while texting. This is the equivalent of driving 100 yards at 55 mph;
13% of drivers ages 18-20 admitted to texting or talking on phone at the time of an accident;
46% of drivers under 18 admitted to texting while driving;
Teens who text spend 10% of their driving time outside their lane;
Texting while driving makes you 23% more likely to crash your vehicle;
Texting while driving causes a 400% increase in time spent with your eyes off the road; and
Texting and driving kills 11 teens a day.

In short, texting, or viewing of a phone, tablet, or other handheld device while driving, is exceedingly dangerous. In fact, a May 2013 study found that texting while driving is the leading cause of death for teen drivers. And, unfortunately, no amount of assurance from a teen (or other) driver will insure that texting or phone viewing (i.e., web browsing, etc.) or other distractions while driving will not occur.

Therefore, the need exists for an engine, system and method of providing wireless signal interruption for mobile device signals while in vehicle.

### SUMMARY

The present invention includes at least an engine, system and method of providing wireless signal interruption for mobile device signals while in vehicle. The invention includes an electronic device of a portable size, such as the size of a hockey puck, and of a convenient shape so as to be moved about by one hand of a user, such as ovular, round, square, etc., that blocks targeted or all wireless signals while in a vehicle, or while in a portion of a said vehicle. The device may be mounted using a magnetic application somewhere inside the engine compartment area of a vehicle or on one side of the roof of the vehicle, on a door of the vehicle, or within the cab of the vehicle, such as via a Velcro, tape or like-adherent mounting, and such as to a window surface or other interior cab surface.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in similar apparatuses, systems, and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to the disclosed elements and methods known to those skilled in the art.

The disclosure is directed to an electronic device of a portable size, such as the size of a hockey puck, and of a convenient shape so as to be moved about by one hand of a user, such as ovular, round, square, etc., that blocks targeted or all wireless signals while in a vehicle, or while in a portion of a said vehicle. The device may be mounted using a magnetic application somewhere inside the engine compartment area of a vehicle or one side of the roof of the vehicle, on a door of the vehicle, or within the cab of the vehicle, such as via a Velcro or tape or like-adherent mounting, and such as to a window surface or other interior cab surface.

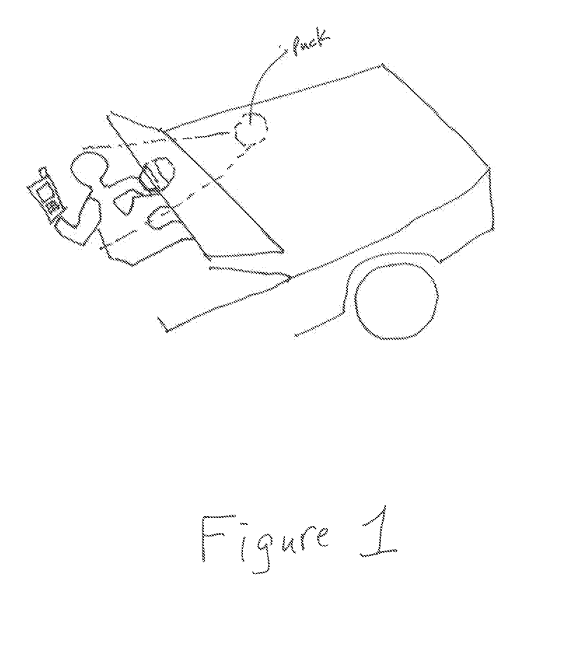

In an exemplary embodiment illustrated with reference to FIG. 1, placement of the device under the hood may eliminate the chance of it being stolen, as the hood is typically locked and can only be unlocked using a latch inside the vehicle. Likewise, mounting within the cab of the vehicle would prevent theft.

The removable, such as magnetic, Velcro, or other adherent design allows the device to be moved from one vehicle to another, such as when family, or particular drivers within the family, switch cars. The inventive device may be comprised of electronic components that will cover the vehicle, or portions thereof, in a “blanket” of wireless signal protection in a particular area. For example, such an area may be +/− a 3-foot radius around the vehicle, or solely in the driver's seat of the vehicle, dependent upon the tuning of the puck. The design may thus affect only the vehicle driver, or the design may minimize the potential distraction to drivers brought on by passengers checking their cellular devices as well.

By way of non-limiting example, the “blanket” may be comprised of a scrambling signal, such as a noise signal, jamming signal, disrupting signal, and/or like interfering signal having a frequency matched to disrupt the radio signals directed for receipt and/or transmission to or from the cellular device antenna. Thereby, the device may include electronics suitable for radio signal generation, as will be understood to those skilled in the pertinent arts. It goes without saying that it is preferred that the blanket will not interfere with the vehicle's operations, or with any of the functions or systems provided in the vehicle, including, for example, OnStar, BMW Assist, and the like. Further, the puck may include one or more microprocessors, and one or more memory components in association with such microprocessor, to allow for the performance of the systems, methods, and functions described herein.

Moreover, the antenna/emitter of the puck may be suitably tuned, such as directionally and by signal magnitude, to cover only that portions or those portions of the vehicle desired. For example, the puck may include a wireless (or wired) interface to a graphical-user interface (GUI), such as may be provided on a computing device, such as on an “app” related to and communicative with the electronic device. Through the use of this GUI, an administrator may “tune” the puck to the desired performance, and, further, the administrator may password-protect the ability to tune the puck such that affected drivers, such as teenagers, cannot modify the tuning using the GUI absent knowledge of the password. Of course, those skilled in the art will appreciate that the puck may also be provided with manually-actuatable controls, whereby tuning may be performed manually on the puck.

Additionally, to the extent the device is equipped with Wi-Fi, Bluetooth, NFC, or like capabilities, the device may be uniquely profiled, such as using the aforementioned GUI, to sense and perform to a particular user device. Accordingly, the device may perform particular, indicated functions in the presence of a first user mobile device, but may perform different functions in the presence of a second mobile device. For example, to the extent the mobile device is actuated using the vehicle's Bluetooth system, i.e., the phone is being employed in hands-free mode, operation of the phone to make and/or receive calls may be enabled for particular devices (for example, parents, who may be less distracted by talking while driving, may be enabled to talk using the vehicle's hands-free mode, such as via a removal of the blanket in such a mode, while younger drivers, who may be distracted even by talking while driving, may not have this feature enabled for their respective devices.

In the event of an accident, such as wherein a driver is immobile and unable to get outside of the minimum distance required to receive a wireless signal, typically 3 feet, a safety net is built in allowing any 911 call to shut off the device's blocking capabilities and seek out an emergency signal, thus allowing the call to connect.

If the driver or any passengers need to use their cellular phones, they can simply park the vehicle, walk outside the device's radius, and operate the device as normal. Additionally and alternatively, the device may sense the vehicle's movement (such as via accelerometers and/or gyroscopic sensors), and may automatically deactivate if the vehicle ceases to move or appreciably slows its motion.

The device may be powered by a lithium ion battery, which can be recharged using a home charging kit. Similarly, the device may be powered and/or recharged via a 12V (or similar) vehicle-interfaced charging unit.

The device may also relay a signal back to a “home base” device, confirming the device is active and functioning. Likewise, the home base signal may include a GPS location or the like, and as such may allow for display of vehicle location, and/or speed, and/or device operability, on the aforementioned GUI. Further, should the device be removed from the vehicle, turned off, or otherwise disrupted, the “home base” may receive a distress signal.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A movable, handheld-sized electronic device, comprising:
an adherent for temporarily attaching the device to a moving vehicle;
at least one directional antenna for directing one or more wireless signals within the vehicle;
at least one signal generator for generating a jamming signal one of the wireless signals suitable to jam radio communications of a second device within the moving vehicle and within a field of the directional antenna; and
a communicative connection for communication via at least one network with a graphical user interface suitable for controlling the signal generator.

2. The device of claim 1, wherein the adherent is comprised of at least one selected from the group consisting of magnetic, Velcro, and tape.

3. The device of claim 1, wherein the field of the directional antenna comprises a +/− 3 foot radial field.

4. The device of claim 1, wherein the jamming signal is one selected from the group consisting of a noise signal, a disrupting signal, and an interfering signal.

5. The device of claim 1, wherein the jamming signal has a frequency matched to disrupt the radio signals directed for receipt and transmission to or from the second device.
